(19) United States
(12) Patent Application Publication
(10) Pub. No.: US 2013/0060651 A1
(43) Pub. Date: Mar. 7, 2013

(54) Method and system for web based job portal

(71) Applicant: Ram Sarma Konduri, Hanover Park, IL (US)

(72) Inventor: Ram Sarma Konduri, Hanover Park, IL (US)

(21) Appl. No.: 13/573,220

(22) Filed: Aug. 30, 2012

Related U.S. Application Data
(60) Provisional application No. 61/573,105, filed on Sep. 1, 2011.

(51) Int. Cl. G06Q 10/06; G06Q 30/08

(52) U.S. Cl. 705/26.3

(57) ABSTRACT

A pre-paid fee based Job Portal method comprises in-depth and up-front verification of all job seekers and employers. A job seeker can also earn by interviewing other job seekers; he-she may also bid on projects as an individual or in a group. An employer can view verified job seeker's profile with prescreened reports. An employer can post projects for a job seeker to bid.

### CROSS REFERENCE TO RELATED APPLICATION

This application claims the benefit of provisional patent application, U.S. 61/573,105, filed Sep. 1, 2011.

### FEDERALLY SPONSORED RESEARCH

Not applicable

### SEQUENCE LISTING OR PROGRAM

Not applicable

### BACKGROUND OF THE INVENTION

1. Field of Invention

This invention relates to a web based recruiting process normally known as “Job Portal”. The Job Portal and its method will establish credibility for both Job Seekers and Employers by authentic verification in human resource recruiting process.

2. Prior Art

The prior art Job Portals are inadequate for employers to find real experienced Job Seekers. An employer is forced to take the help of multiple sources such as Staffing Companies, Employee Referrals, Social Media, third party Human Resource Software applications and other job portals to find a Job Seeker.

Prior art Job Portals have a very limited functionality to fill staffing needs. The disadvantages of them are:
1. Proper investigation of Job Portal users such as Employers and Job Seekers does not exist;
2. A Job Seeker can post a misleading resume;
3. A particular job is often displayed by multiple Staffing Companies; as a result the Job Seeker is misled by the number of job opportunities and the reality of an Employer;
4. Many Employers post fictitious jobs, resulting in misleading opportunities for a Job Seeker;
5. A Job seeker has no earning model other than finding employment;
6. Job Seeker's profile continues to remain visible to other employers, even after accepting a job offer from a new employer;
7. There is no facility for a Job Seeker to bid for projects directly;
8. Employers have to go through much ordeal in multiple ways to find an experienced Job Seeker, resulting in wastage of time;
9. Since Employers have no credible web based Job Portal, Employers incur heavy expenditure to find a Job Seeker;
10. A Job Seeker negotiates with multiple Employers, before reporting to a new Employer. As a result Employer is not sure about the Job Seeker joining the company, even after Job Seeker accepts the job offer;
11. Employers face difficulties to reduce the expenditure on Information Technology projects, as there is no facility for employers to post projects in job portals so that Job Seekers may bid for the projects;
12. To reduce the expenditure on projects, Employers outsource the work to other countries.

### OBJECTIVES AND ADVANTAGES

Accordingly, the objectives and advantages of the new Job Portal that overcome the disadvantages of the prior art are itemized below:
1. Job Seekers and Employers are thoroughly screened before they can start using the new Job Portal;
2. Real jobs are displayed, and hence Job Seekers have to spend minimal time in finding new opportunities;
3. Screened Job Seekers and screened Employers are connected directly; reducing the multiple middle layers and multiple postings for a single job;
4. Senior Job Seekers are allowed to register as interviewers. A senior Job Seeker can earn revenue for each interview specified by the new Job Portal;
5. Once a Job Seeker accepts an offer from an Employer, the new Job Portal hides the profile from other recruiters for a specified brief period; as a result other Job Seekers will have a better chance in finding new opportunities;
6. The new Job Portal will allow a Job Seeker either as an individual or as a representative of a group to offer consulting services. As a result a Job Seeker or the group can bid for the projects posted by Employers. Because of these options, a Job Seeker can earn on temporary basis;
7. The new Job Portal will refund the registration fee to the Job Seeker, after finding new job opportunities through the new Job Portal; as a result registration will be free for the Job Seeker;
8. An Employer does not need to go through much ordeal with multiple sources to find a job seeker;
9. Screened profiles of a Job Seeker with verification reports are displayed to the Employer for better decision process;
10. The new Job Portal will allow an Employer to download the pre-screened reports of a Job Seeker; as a result an Employer can avoid repeated background verification of a Job Seeker;
11. An Employer can advertise projects in the new Job Portal to attract Job Seekers to bid for the projects; as a result the Employers can reduce project expenditure and Job Seekers can increase their earnings.

### SUMMARY

The new Job Portal reduces complexity and establishes credibility in web based recruiting process. A Job Seeker can earn in addition to seeking job opportunities. An Employer does not need to depend on multiple sources for their staffing need. An Employer can find credible Job Seekers with ease in addition to reducing the cost for projects. As a result an Employer will save time, expenditure and avoid outsourcing the work.

### DRAWINGS, FIGURES

FIG. 1 Block diagram of method and system for new Job Portal

FIG. 2 Continuation of FIG. 1

FIG. 3 Job Seeker flow diagram

FIG. 4 Continuation of FIG. 3

FIG. 5 Employer flow diagram

FIG. 6 Continuation of FIG. 5

### REFERENCE NUMERALS

18 Start—Begin Job Seeker's method in the new Job Portal
20 Job seeker
24 Registration process—Job Seeker will submit profile, credentials and registration fees
26 Job Portal server—An Information Technology application server for the Job Portal
28 Forward credentials—Job Portal will forward Job Seeker's credentials for background verification
30 Accredited agency—An agency to do background verification of job seeker
32 Report 1—Background report of a Job Seeker by an accredited agency
34 Job Seeker's in person interview and credential's verification
35 Report 2—Report on interview and credentials
36 Job Seeker credibility—A decision process based on report 1&2
37 Identify and fix issues-1—Addressing any issues related to credentials and communicating to Job Seeker to resolve
38 Report 3—Comprehensive report generation from both report 1 and report 2
39 Authorizing job seeker—The Job Portal authenticates the successfully completion of screening process of Job Seeker
40 Information update in server—Job seeker's status is updated to active job seeker in Job Portal
41 Access to Job Seeker's functions—Job Seeker can access Job Seeker's feature defined by the Job Portal
42 Active job seeker—Job Seeker to check the access of his/her account in Job Portal
43 Identify and fix issues-2—Address the issues related to login for Job Seeker and resolve them
45 Prescreened Job Seeker—Successfully screened Job Seeker who is allowed to use Job Portal
46 Apply for jobs—Active Job Seeker search for jobs and submits his/her profile
47 Confirm placement—Employer confirms the Job seeker's appointment
48 Refund registration fee—Job Portal will refund the registration fee to the Job Seeker
49 Interview other job seeker—Active Job seeker interviewing the other junior job seekers
50 Bid for projects—Active Job Seeker bid for projects
51 Receive payment—Active Job Seeker receiving payments from Job Portal, based on the interviews specified by Job Portal
52 End—End of active Job Seeker's method
53 Start—Begin of Employer's method in the new Job Portal
54 Employer
55 Registration process—Employer will submit the documents and registration fee
56 Forward documents—Job Portal will forwarded Employer's documents for background verification
57 Accredited agency—An agency to do background verification of Employer
58 Verification report—Background report of Employer from accredited agency
59 Employer's credibility—Credibility decision on Employer's report
60 Identify and fix issues-3—Addressing the issues and communicating to Employer to resolve them
61 Compressive report generation for the employer
62 Authorizing Employer—The Job Portal authenticates the successfully completion of screening process of an Employer
63 Information update in server-Employer's status is updated to active Employer in Job Portal
64 Active Employer—Employer to check the access of his/her account in Job Portal
65 Identify and fix issues-4—Address the issues related to login for Employer and resolve them
66 Prescreened Employer—Successfully prescreened Employer who is allowed to use Job Portal
69 Access to Employer's functions—Active Employer can access employer's features defined by the Job Portal
70 End—End of active Employers method in Job Portal
72 Profile non searchable—Job Portal hides the active Job Seeker's profile from other recruiters
98 Physical/Remote network connection between the servers

### DETAIL DESCRIPTION OF METHOD AND SYSTEM FOR WEB BASED JOB PORTAL

The Method and system for web based Job portal is used to describe a software application built to carry detailed functions for Job Seekers and Employers. The method is incorporated in developing the new Job Portal for human resource recruiting process.

The method achieves:
(i) Credibility for both Job Seekers and Employers;
(ii) A Job Seeker can earn in addition to seeking job opportunities;
(iii) An Employer can reduce project expenditure in addition to finding credible job seekers.

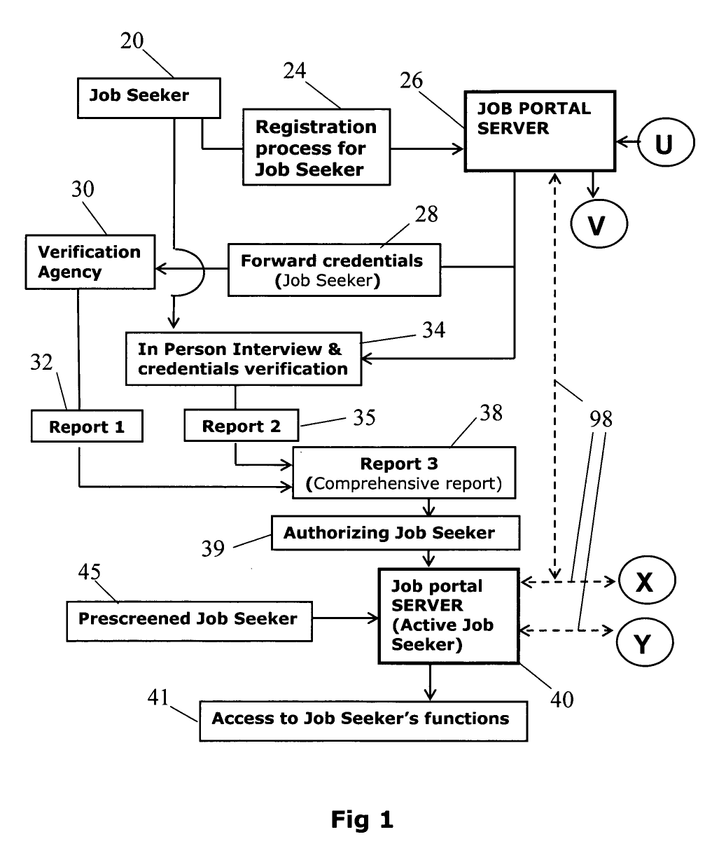

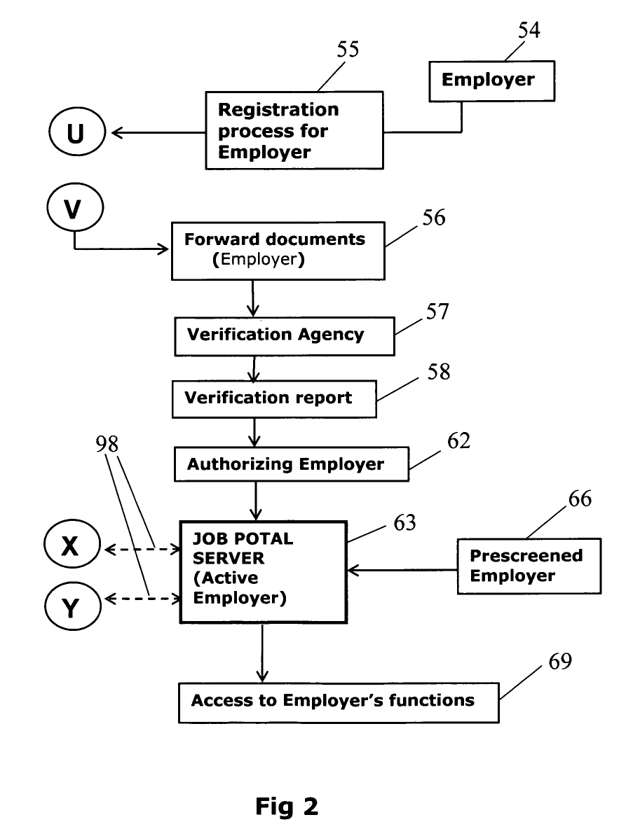

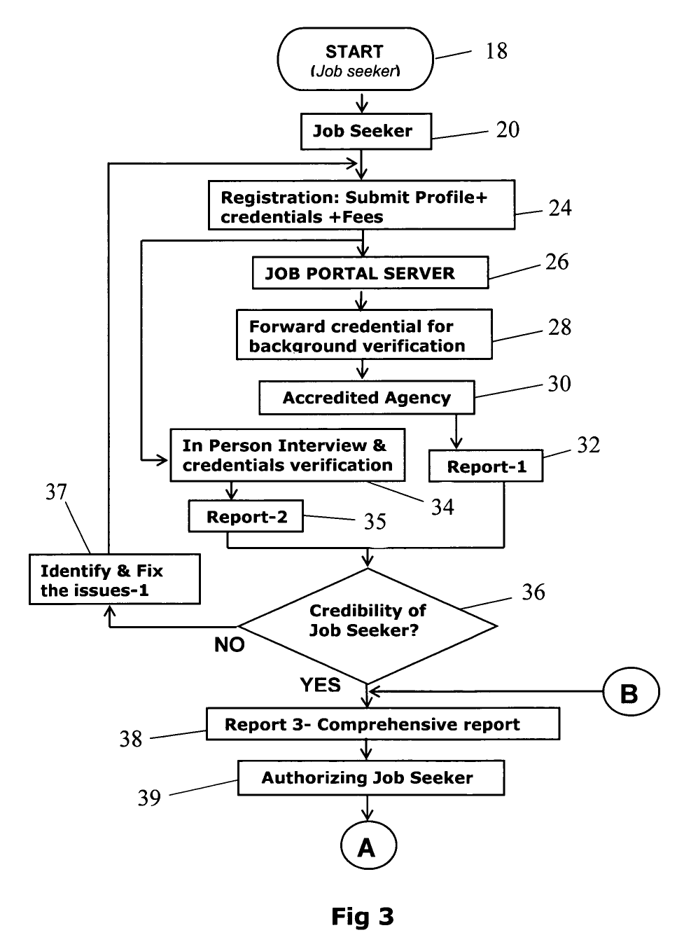

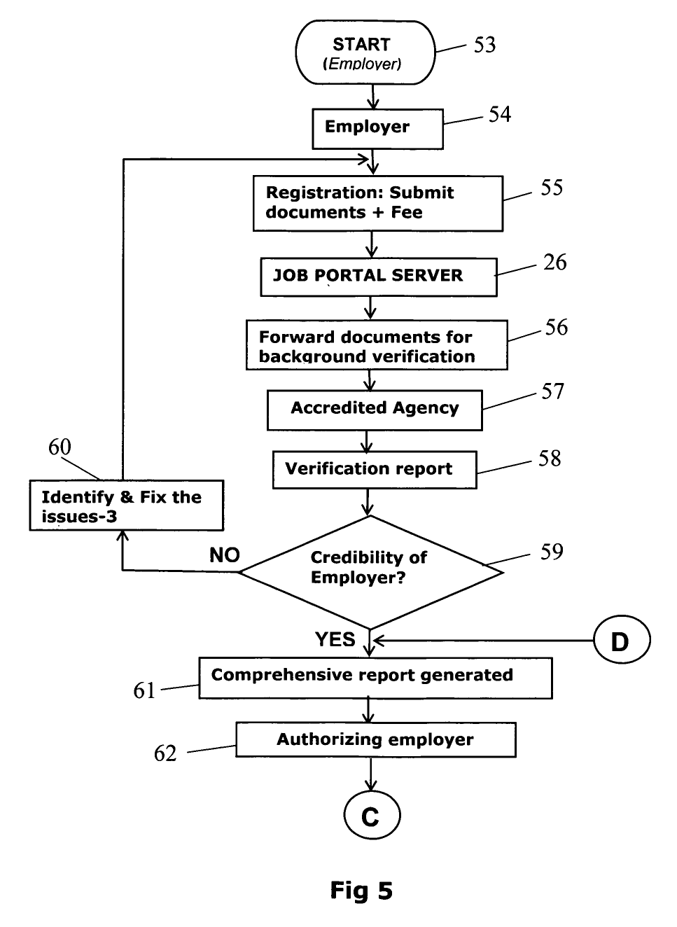

FIGS. 1 & 2 explains the overall view of the method in a block diagram. The diagram show the major steps followed by Job Seekers and Employers in said Job Portal. The connectors U, V, X and Y connect FIGS. 1 and 2. Job Portal Server (#26), active Job Seekers Server (#40) and active Employers Server (#63) are networked physically or remote (#98). The detail flow diagrams of job seeker (FIGS. 3 & 4) and employer (FIGS. 5 & 6) describe the new Job Portal.

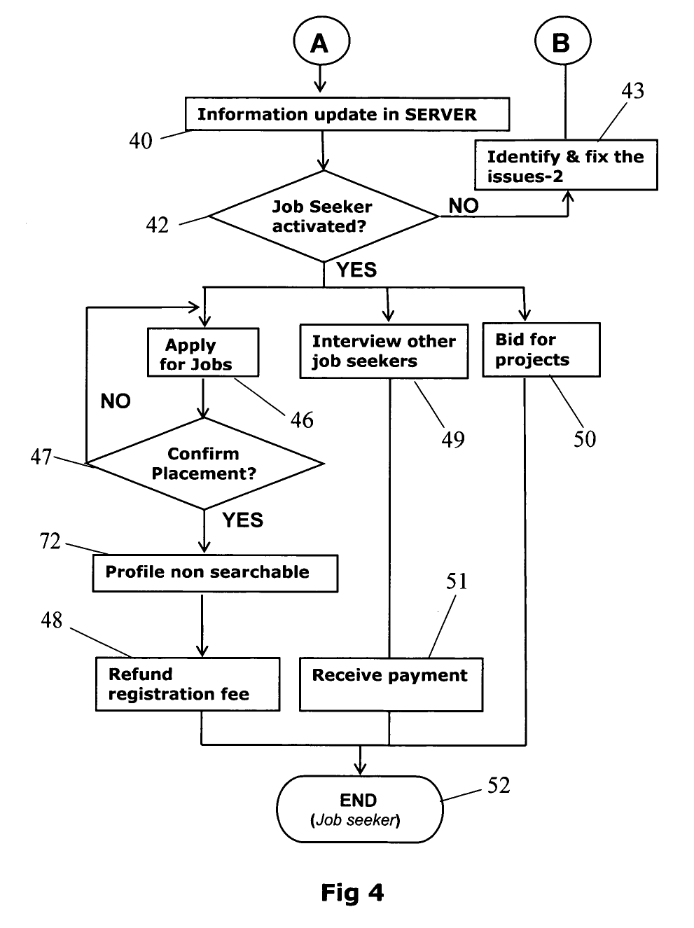

FIGS. 3 and 4 show the flow diagram of a Job Seeker. A Job Seeker needs to complete a registration process before he/she can start using the Job Portal. A Job seeker(#20) starts (#18) the method by navigating to the job seekers software application in Job Portal Server(#26). A Job Seeker (#20) submits his/her credentials & registration fee (#24) along with required personal information to register in the Job Portal (#26). Once the registration process is complete the Job Portal will forward the Job Seeker's credentials(#28) to an accredited agency(#30) for a comprehensive background verification, namely education, references, work experience, work status, criminal background etc., once the verification process is complete the agency will forward a report (Report 1, #32) to the Job Portal.

The Job Portal will schedule the Job Seeker for an in person interview(#34) with a senior Job Seeker to access the Job Seeker's skills and verify the credentials submitted during the registration process. After personal verification of documents and interview, interviewer will generate a report (Report 2, #35). Based on the report 1 & 2 the Job Seekers credibility is decided (#36), if some issues arise (#37), the Job Seeker is advised by the job portal to review Job Seeker's documents and resubmit to the Job Portal. The process is repeated till the Job Seeker's credibility is established. A Job Seeker will be given fair number of chances to prove his/her credibility. Once the credibility is established the Job Portal will create a comprehensive report (Report 3,#38) of the Job Seeker, later the Job Portal will authenticate (#39) the successful completion of the Job Seeker's screening process . The Job Seeker information is updated in active Job Seeker Server (#40).

The Job seeker's active status is verified (#42), if the result is YES, the prescreened Job Seeker (FIG. 1, #45) can access the Job Seeker's features(#41) provided in Job Portal. A Job Seeker has three major functions in addition to managing his/her registered account. If the result is NO, issues are identified and resolved (#43). The three major functions are:
(a) Search and apply for new jobs(#46);
(b) Senior Job Seekers can register to interview the other job seekers(#49);
(c) Job seekers can bid for projects (#50) either as an individual or as a group of professionals to offer his/her professional services.

If a Job Seeker is successful in finding a new job through the Job portal, the Job portal will hide the Job Seeker's profile (#72) for a specified brief period. The Job Seeker will recuperate the registration fee(#48), once the Employer confirms the Job Seeker's appointment(#47), to the Job Portal.

Once a senior Job Seeker registers as an interviewer, the Job Portal will assign other junior Job Seekers who are due for interview. An interviewer can earn revenue (#51) on temporary basis for each interview as specified by the Job Portal. A Job Seeker can end (#52) the session by simple log out option, provided in the Job Portal.

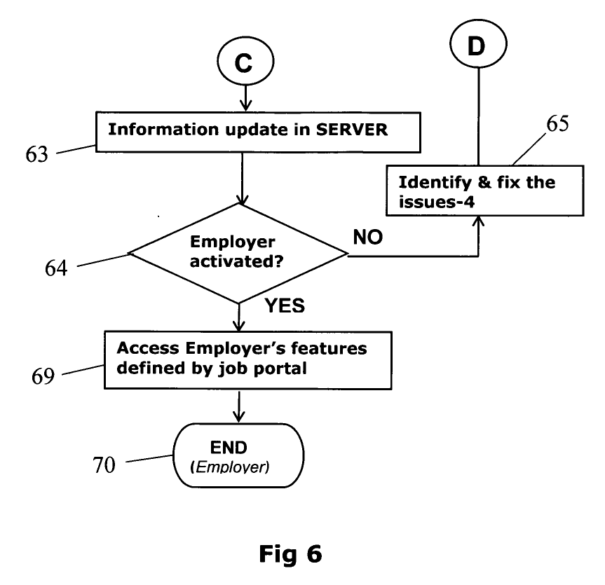

FIGS. 5 and 6 show the flow diagram of an Employer. An authorized executive of an Employer needs to complete the registration process before he/she can start using the Job Portal. An Employer (#54) starts (#53) the method by navigating to employer software application in the Job Portal Server (# 26). An Employer (#54) submits documents & registration fee (#55) along with required Employer's information to register in the Job Portal (#26). Once the registration process is complete the Job Portal will forward (#56) the documents to an accredited employer's verification agency (#57) for comprehensive background verification. Once the verification process is complete the agency will forward a report (#58) to the Job Portal. Based on the report the Employer's credibility is decided (#59), if some issues arise, the Employer will be advised by the Job Portal to review Employer's documents (#60) and resubmit to the Job Portal. The process is repeated till the Employer credibility established. An Employer will be given fair number of chances to prove their credibility. Once the credibility is established the Job Portal will create a comprehensive report (#61) on Employer. Later the Job Portal will authenticate (#62) the completion of screening process. The employer information is update in active Employer Server (#63).

The Employer active status is verified (#64), if the result is YES; the prescreened Employer (#66) can carry two major functions (#69) in addition to managing Employer's registered account. If the result is NO, issues are identified and resolved (#65). The two major functions are:
(a) search profiles with screened reports and post jobs
(b) An Employer can post project for a Job Seekers to offer their professional services

An Employer can end (#70) the session by simple log out option, provided in the Job Portal.

### CONCLUSION, RAMIFICATIONS, AND SCOPE

Accordingly, the reader will see that with the invention presented, ‘Method and system for web based job portal’ removes the huge complexity in web based Human Resource recruiting process. The new Job portal will bridge the gap between the Employers and Job Seekers by establishing a credible web based environment for the staffing industry. Job Seekers and Employers can achieve their objectives in a least possible time and expenditure.

Job Seekers can have additional functions to grow their careers not limiting to finding jobs. Employers can save time and resources on recruiting permanent and temporary staff for their companies. Employers can also reduce expenditure on Information Technology projects. As a result Employers can avoid outsourcing the work to other countries.

The new Job Portal will create good number of jobs that would facilitate the US economy to grow.

I claim:

1. A method for a web based job portal, wherein said method comprises:
(a) a means for a job seeker to prepay said job portal, and
(b) a means for said job seeker to submit said job seeker's credentials to said job portal, and
(c) a means to verify said job seeker's credentials, and
(d) a means to interview said job seeker by another job seeker of said job portal, wherein said another job seeker is senior to said job seeker, and
(e) a means to create a verified report on said job seeker's credential, and
(f) a means for said senior job seeker to earn by interviewing said job seeker, and
(g) a means for said job seeker to bid for projects, and
(h) a means for said job seeker to form a group with other job seekers from said job portal, and
(i) a means for a said group to bid for projects posted by an employer, and
(j) a means for said job portal to hide said job seeker's profile, and
(k) a means for said job seeker to be reimbursed the said prepayment, and
(l) a means for said employer to prepay said job portal, and
(m) a means for said employer to submit said employer's credentials to said job portal, and
(n) a means for said job portal to verify said employer's credentials, and
(o) a means for said employer to access said verified report of said job seeker, and
(p) a means for said employer to post projects in said job portal.

2. In claim 1, item(d), said means to interview said job seeker comprises a means for said senior job seeker to interview to access the skills of said job seeker, whereby complete skill assessment of said job seeker is achieved.

3. In claim 1, item(j), said means for job portal to hide said job seeker's profile comprises a means said job portal will hide said job seeker's profile for a specified brief period, after said employer confirms the new appointment of said job seeker, whereby other job seeker can have better chance to find new job opportunities can be achieved.

4. In claim 1, item(k), a means for said job seeker to be reimbursed said prepayment comprises a means for said job portal to refund the registration fees back to the job seeker after said employer confirms the said job seeker's new appointment, whereby registration fees for a job seeker will be free can be achieved.
